(19) United States
(12) Patent Application Publication
(10) Pub. No.: US 2003/0083008 A1
(43) Pub. Date: May 1, 2003

(54) Method and system for identifying repeater traffic in a code divsion multiple access system

(76) Inventors: Kenneth R. Baker, Boulder, CO (US); Brian K. Butler, La Jolla, CA (US)

Correspondence Address: Qualcomm Incorporated, Patents Department, 5775 Morehouse Drive, San Diego, CA, 92121-1714, US

(21) Appl. No.: 10/004,177

(22) Filed: Oct. 25, 2001

(51) Int. Cl. H04B 3/36; H04B 7/15; H04B 7/14

(52) U.S. Cl. 455/17; 455/11.1

(57) ABSTRACT

An apparatus and method for identifying remote communications transmitted via a repeater from remote communications not transmitted via the repeater. The method comprises the steps of receiving a signal transmission 124A from a remote station 112, determining if the signal transmission 124A includes a discriminant applied to the signal transmitted from the remote station 112 and designating the signal transmission 124A as being transmitted via the repeater 120 if the signal transmission 124A includes the discriminant.

### BACKGROUND OF THE INVENTION

1. Field of the Invention

The present invention relates to methods and systems for transcieving information between mobile stations and base stations, and in particular to a method and system for determining if a message received at a base station was transmitted via a repeater.

2. Description of the Related Art

Cellular telephone (cellphone) service has become widespread. In some service areas, it has become mandatory that cellphone service providers incorporate features into the cellphone network that allow the location of the cellphone user. These services are useful for, among other things, emergency calls (911 and the like).

In providing this service, difficulties arise when the cellphone user is communicating with the base station of the cell via a repeater. In such circumstances, the position determination system cannot distinguish where the cellphone user is, since such systems typically do not identify the signal from the user as having been received from the repeater, and the usual means of determining the user's location (e.g. triangulation using signal strength and other signal measures) can be compromised by passing through the repeater).

It is also desirable in some circumstances to determine the level of network traffic, particularly traffic through the repeaters. This capability is also difficult to implement unless the base stations are capable of identifying which received transmissions were received via the repeater and which were not (e.g. received directly from the cellphone).

What is needed is a simple system and method for identifying whether a particular cellphone transmission was received directly from the mobile station, or whether the transmission was received via a repeater. The present invention satisfies that need.

### SUMMARY OF THE INVENTION

To address the requirements described above, the present invention discloses a method and apparatus for identifying remote communications transmitted via a repeater from remote communications not transmitted via the repeater. The method comprises the steps of receiving a signal transmission from a remote station; determining if the signal transmission includes a discriminant applied to the signal transmitted from the remote station; and designating the signal transmission as being transmitted via the repeater if the signal transmission includes the discriminant. The apparatus comprises a receiver configured to receive a signal transmission from a remote station and a processor configured to determine if the signal transmission includes a discriminant applied to the signal transmitted from the remote station and to designate the signal transmission as being transmitted via the repeater if the signal transmission includes the discriminant.

### BRIEF DESCRIPTION OF THE DRAWINGS

Referring now to the drawings in which like reference numbers represent corresponding parts throughout:

FIG. 1 is a diagram of a cellular telephone system;

FIG. 2 is a flow chart illustrating exemplary process steps that can be used to practice one embodiment of the present invention;

FIG. 3 is a block diagram of a prior art repeater;

FIG. 4 is a block diagram of one embodiment of a repeater of the present invention;

FIG. 5 is a diagram presenting an illustrative embodiment of the present invention employing amplitude modulation (AM);

FIG. 6 is a diagram presenting an illustrative embodiment of the present invention employing delay modulation;

FIG. 7 presents a basic repeater configuration with respect to the orientation relative to remote station, the base station, and the repeater;

FIG. 8 is a diagram showing a repeater configuration in which the link from the repeater to the base station is accomplished via a landline such as a coaxial or fiber optic cable;

FIG. 9 is a diagram showing a repeater configuration in which the server antenna is not a single antenna, but a plurality of antennae distributed in a plurality of locations; and

FIG. 10 shows one embodiment of base station elements, which distinguishes signals received from the remote station via a repeater from signals received directly of the base station.

### DETAILED DESCRIPTION OF THE PREFERRED EMBODIMENT

In the following description of the preferred embodiment, reference is made to the accompanying drawings, which form a part hereof, and in which is shown by way of illustration a specific embodiment in which the invention may be practiced. It is to be understood that other embodiments may be utilized and structural changes may be made without departing from the scope of the present invention.

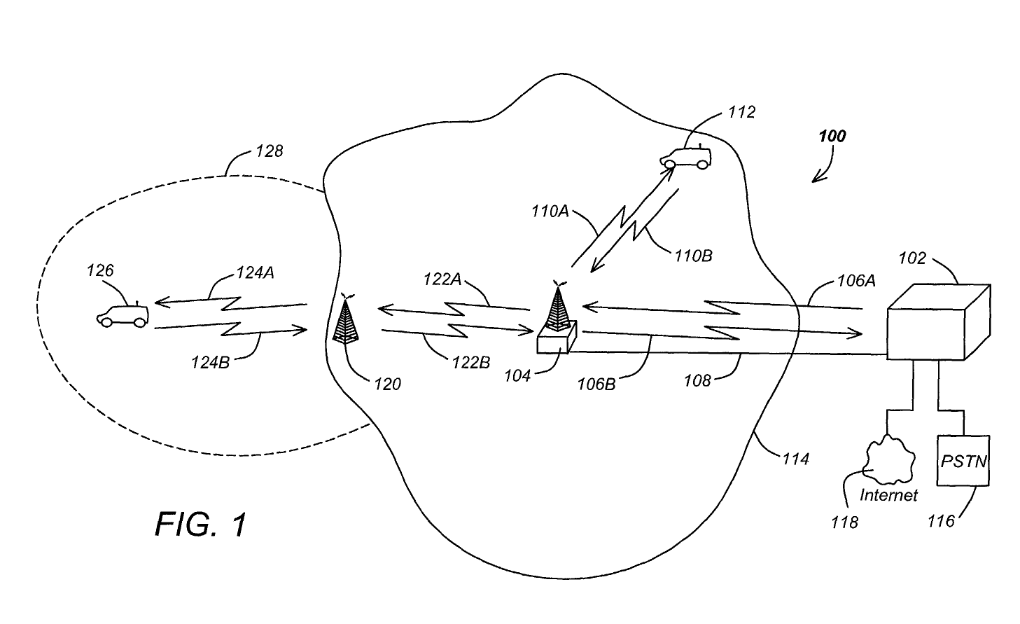

FIG. 1 is a diagram of a cellular telephone system 100. The cellular telephone system 100 comprises one or more control stations 102, and a plurality of base stations 104. The base stations 104 communicate with remote stations 112 that are within the service area 114 of the base station 104. The remote stations 112 may be mobile stations (e.g. car phones or handheld cellphones) or fixed stations. The service area 114 is generally described as the geographical extent of a locus of points for which a remote station 112 can communicate effectively with the base station. Although the shape of the service area 114 is illustrated as more or less circular in FIG. 1, the actual shape is dictated by geographical obstructions and other factors. Multiple service areas 114 generally overlap to provide cellular telephone service over a wide area.

When a remote station 112 is within the service area 114, messages can be transmitted from the control center 102 to the base station 104 via forward link 106A, and from the base station 104 to the remote station 112 via forward link 110A. Messages are transmitted from the remote station 112 to the base station 104. These messages are transmitted to the control center 102 via the return link 106B. Some or all of the communications between the base station 104 and the control station 102 can be carried via landline 108 if desired. Also, messages transmitted via the forward links 106A and 110A are typically modulated in different frequency bands or modulation techniques than the messages transmitted via reverse links 10B and 106B. The use of separate forward and reverse links allows full duplex communications between the control center 102 and the remote station 112.

The control station 102 is communicatively coupled to other communication portals such as the public switched telephone network (PSTN) 116 or the Internet 118. Thus, the user at the remote station 112 is provided with access to the communication portals via the cellular telephone system 100.

While it is possible to extend coverage of the cellular telephone network 100 by simply adding more base stations 104 to cover additional geographical territory, it is sometimes uneconomical to do so. In many cases, for example, the territory sought to be covered has enough traffic to justify the use of a repeater 120 instead of a base station. The repeater 120 accepts transmissions from both the mobile station 126 and the base station 104 and acts as an intermediary between the two, essentially a “bent pipe” communication portal. Using the repeater 120, the effective range of the base station 104 is extended to cover extended service area 128.

While the use of repeaters 120 is a cost effective way to increase range, it has its disadvantages. The use of a large number of repeaters 120 instead of additional base stations 104 places greater demands on the base stations 104 to handle traffic (since the base station 104 is handling traffic for an extended service area 128). Further, use of the repeater 120 also compromises the ability of the system to determine the location of the remote station 126. At least in part, this is due to the fact that signals passing through the repeater are subject to delays that are not present in signals that are transmitted directly from the remote station 126 to the base station 104.

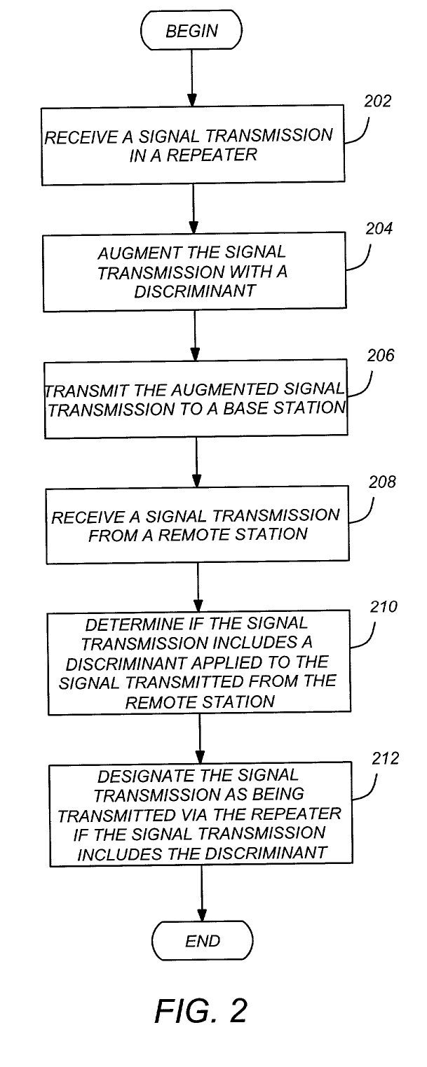

FIG. 2 is a flow chart illustrating exemplary process steps that can be used to ameliorate the foregoing shortcomings of the cellular telephone system 100. A signal transmission is received from a remote station 126 in a repeater 120, as shown in block 202. The signal transmission is augmented with a discriminant, as shown in block 204. This can occur in the repeater 120 itself or in a device communicatively coupled to the repeater 120. Then, the augmented signal is transmitted from the repeater 120 and received in the base station 104, as shown in blocks 206 and 208. In block 210, a determination is made as to whether the received transmission includes the discriminant applied by the repeater 120. Since transmissions received via the repeater 120 will include that discriminant and transmissions received in the base station 104 directly from the remote station 112 will not, a determination can be made as to whether the transmission was received via the repeater 120 or not. If the discriminant is present in the received signal, then the transmission is designated as received via the repeater 120, as shown in block 212. At this point, the data received with regard to this transmission are associated with the repeater, and algorithms that compute the position of the remote station 126 or determine network traffic can reflect this reality.

The present invention is not limited to embodiments wherein a signal characteristic is added to the transmission signal. The foregoing could also be implemented by a system in which the repeater removes rather than adds the signal characteristic (e.g. the signal directly from the remote stations 112 may include a modulation, delay or other information that is removed by the repeater before transmission). However, even in this case, the signal passing through the repeater 120 is augmented with a discriminant (the discriminant is now the absence of the modulation that other received signals are expected to have).

The discriminant can take many different forms. In one embodiment, the discriminant is a code that is added to the signal received from the remote station 126. This embodiment serves the purpose of identifying the transmission, however, this embodiment requires equipment at the repeater 120 to receive and demodulate the signal received from the remote station 126, add the code to the signal and transmit the signal with the added code to the base station 104. In another embodiment, the discriminant is a modulation that is applied to the signal received at the repeater 120 from the remote station 126. The modulation can be amplitude modulation (AM), frequency modulation (FM), pulse modulation (PM), delay modulation (DM), or any combination of such modulation techniques.

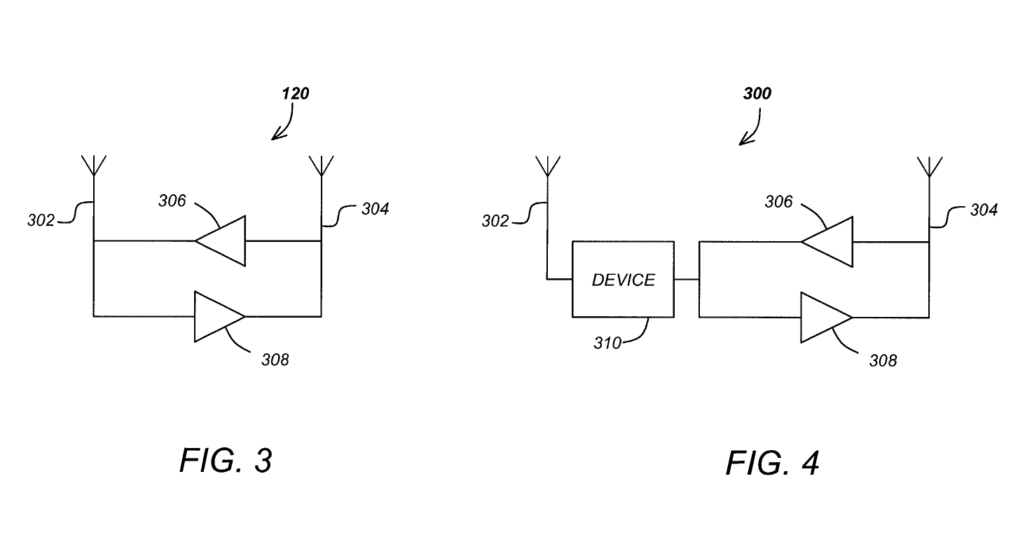

FIG. 3 is a block diagram of a prior art repeater 120. The repeater 120 includes a donor antenna 302 for receiving signals, an amplifier 308 for amplifying signals received at the donor antenna 302 and a server antenna 304 for transmitting (or repeating) signals received by the repeater 120. Also, a second amplifier 306 amplifies signals received at the server antenna 304 and provides the amplified signals to the donor antenna 302. The repeater 120 may also comprise four antennae and four amplifiers, for receiving, amplifying, and transmitting the forward 122A, 124A and reverse link 124B, 122B signals separately.

FIG. 4 is a block diagram of one embodiment of a repeater 300 of the present invention. An add-on device 310 communicatively coupled to the amplifiers 308 and 306 and the donor antenna 302 adds the discriminant. This modification can be accomplished without modification to any of the elements shown in FIG. 3. In one embodiment, the add-on device 310 adds modulation (AM, PM, DM, FM or equivalent) to the return link signal 122B to the base station 104.

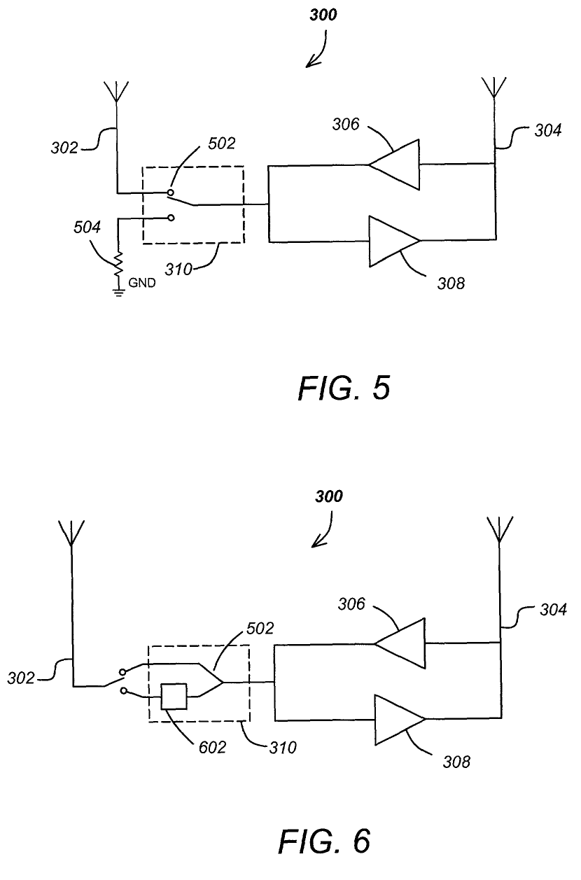

FIG. 5 is a diagram presenting an illustrative embodiment of the present invention employing AM modulation. In this embodiment, the device 310 is a simple switching device 502 allowing the return link 122B to be connected to either the donor antenna 302 or a load 504.

FIG. 6 is a diagram presenting an illustrative embodiment of the present invention employing delay modulation. In this embodiment, the switching device 502 applies the output of the amplifier 306 directly to the server antenna 302 or via a delay line device 602. In the embodiments illustrated in FIG. 5 and FIG. 6, only the return link 122B would be modulated as indicated.

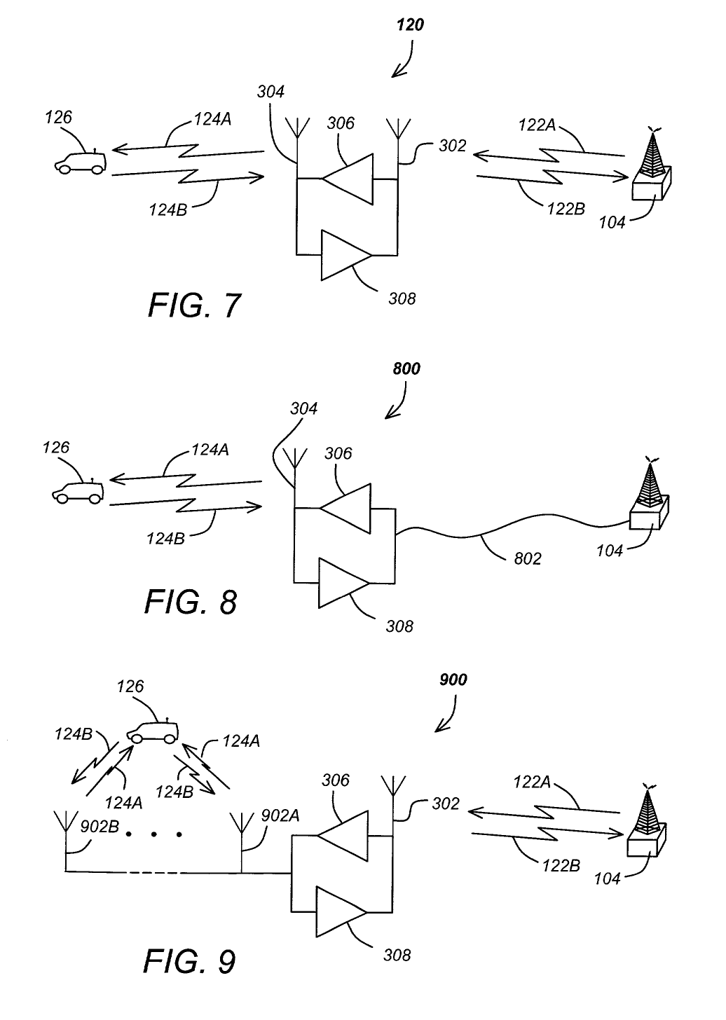

FIGS. 7-9 are diagrams illustrating repeater 120 configurations that can be used in conjunction with the present invention. FIG. 7 presents a basic repeater configuration with respect to the orientation relative to remote station 126 the base station 104 and the repeater. In the embodiment illustrated in FIG. 7, the donor antenna 302 is directed at the base station 104 (or multiple base stations), while the server antenna 304 is generally directed at the remote station 126.

FIG. 8 is a diagram showing a repeater configuration in which the link from the repeater 800 to the base station 104 is accomplished via a landline 802 such as a coaxial or fiber optic cable.

FIG. 9 is a diagram showing a repeater configuration in which the server antenna 902 is not a single antenna, but a plurality of antennae 902A, 902B distributed in a plurality of locations. For example, the antennae 902A, 902B could be disposed on different floors of a building or along the length of a subway tunnel. The connection back to the base station 104 could be via land link (as shown in FIG. 8) or via a radio link (or optical link) as shown in FIG. 7.

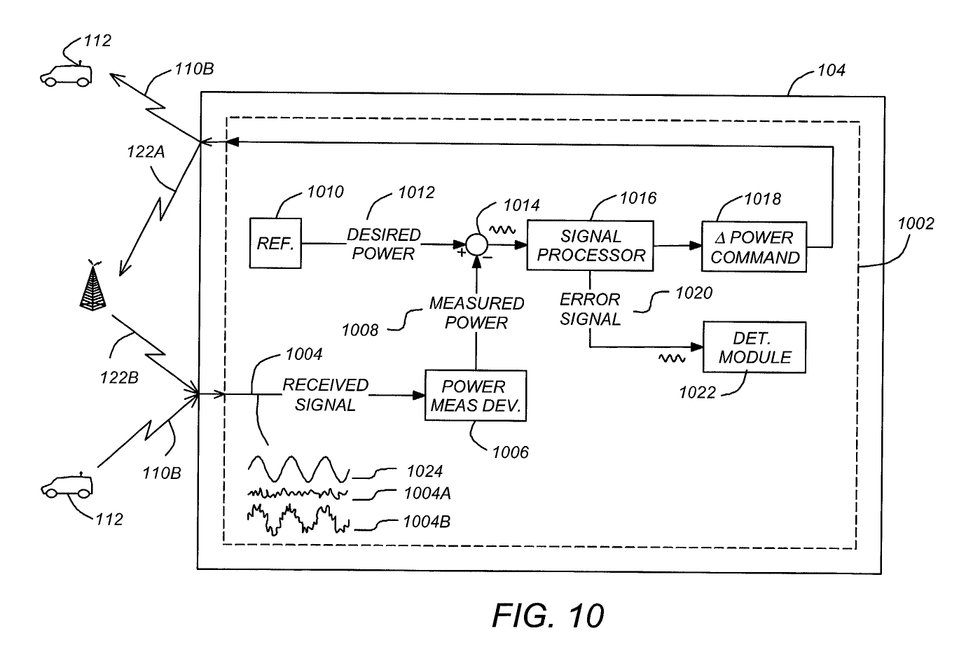

FIG. 10 shows one embodiment of base station 104 elements which distinguishes signals received from the remote station 126 via a repeater 300 from signals received directly of the base station 104. In the illustrated embodiment, the discriminant is an amplitude modulation applied to the signal from the repeater 300.

The base station 104 includes a power control system 1002. The power control system 1002 is used to adjust the transmitter power of the remote station 126. This adjustment prevents remote stations 126 disposed in close proximity to the repeater 120 and/or the base station 104 from overwhelming transmissions from remote stations 126 that are disposed at a greater distance. It also allows the system to increase the power of remote stations 126 that are remote from the base station 104, thus increasing range.

The power control system 1002 accepts the received signal 1004. The received signal 1004 can be received either directly from the remote station 112 (via return link 110B) or from remote station 126 or via the repeater 120. Signals received directly from remote station 112 do not include a discriminant 1024, and may look like element 1004A in FIG. 10. Signals received from the remote station 126 via the repeater 120 include a discriminant (such as element 1024 of FIG. 10), and may appear as shown in element 1004B.

The received signal 1004 is provided to a power measuring device 1006, and a measurement 1008 indicative of the power or quality of service (QoS) of the received signal is generated. This can be a power measurement, an indication of a bit error rate (BER), or any other measurement that is an indication of the proximity of the remote station 112 and/or the potential of that signal to be lost due to insufficient transmit characteristics (power, etc.) or to interfere with signals received from other remote stations 112.

The measured power 1008 is compared to a desired power value 1012 which is obtained from a reference 1010. A difference between the measured power and the reference or desired power is obtained by a device (represented in FIG. 10 by summing junction 1014) and provided to a signal processor 1016. The signal processor 1016 determines whether a change in the transmit power of the remote station 112 is required, and if so, generates either a new power level command or a command describing a change in the power level. That command is transmitted to the remote station via link 110B or 122A or by an independent link.

An error signal 1020 generated by the processor 1016 is provided to a detection module 1022. The detection module 1022 examines the error signal to determine whether the discriminant 1024 is included in the received signal. This allows a determination as to whether the received signal 1004 was received in the base station 104 via a repeater 120 or directly from a remote station 112. If the detection module 1022 determines that the discriminant (e.g. modulation) on the received signal was added by a repeater 120, a determination is made that the signal was received from a remote station 126 via the repeater 120, and appropriate processing (for position determination, traffic analysis, or other purposes) can take place. Further, if the detection module determines that the variations in the received signal 1004 were added by the repeater 120, the detection module 1022 can inform the processor 1016 of this fact so a new power command will not be generated. Alternatively, the frequency or amplitude of the discriminant 1024 can be such that the power control system 1002 does not supply a power control signal (e.g. the frequencies of the added discriminant is sufficiently attenuated by the closed loop response of the power control system 1002 so that the power command is effectively non-existent or negligible).

Although illustrated as a separate device to indicate functionality, the detection module may be implemented in the processor 1016 as well.

Power is just one example of many different remote station 112 transmitter characteristics that may be controlled by the base station 104 to optimize system communications. Other examples include packet size and message bandwidth. As such, the technique of adding a discriminant to signals received and repeated by the repeater can be implemented in a variety of embodiments, including those explicitly set forth above and equivalents thereof.

Conclusion

This concludes the description including the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above teaching.

It is intended that the scope of the invention be limited not by this detailed description, but rather by the claims appended hereto. The above specification, examples and data provide a complete description of the manufacture and use of the apparatus and method of the invention. Since many embodiments of the invention can be made without departing from the scope of the invention, the invention resides in the claims hereinafter appended.

What is claimed is:

1. A method of identifying remote communications transmitted via a repeater, comprising the steps of:
receiving a signal transmission from a remote station;
determining if the signal transmission includes a discriminant applied to the signal transmitted from the remote station; and
designating the signal transmission as being transmitted via the repeater if the signal transmission includes the discriminant.

2. The method of claim 1, wherein the discriminant comprises a code.

3. The method of claim 1, wherein the discriminant comprises a modulation applied to the signal transmission from the remote station.

4. The method of claim 3, wherein the modulation comprises frequency modulation.

5. The method of claim 3, wherein the modulation comprises delay modulation

6. The method of claim 3, wherein the modulation comprises amplitude modulation.

7. The method of claim 6, wherein the repeater comprises an amplifier, and the amplitude modulation is applied to the signal transmission by performing the step of varying a gain of the amplifier.

8. The method of claim 7, wherein the base station comprises a power control system for controlling the strength of the signal transmitted from the remote station, and wherein the amplitude modulation is performed at a frequency higher than the closed-loop bandwidth of the power control system.

9. The method of claim 8, wherein the power control system includes an error signal related to a difference between the strength of the signal transmitted from the remote station and a desired strength of the signal transmitted from the remote station and the step of designating the signal transmission as being transmitted via the repeater if the signal transmitter includes the discriminant comprises the step of:
measuring the error signal; and
designating the signal transmission as communicated via the repeater according to the measured error signal.

10. The method of claim 1, wherein the remote communications can potentially be transmitted from one of a plurality of repeaters and the discriminant is unique to each of the plurality of repeaters.

11. An apparatus for identifying remote communications transmitted via a repeater, comprising:
a receiver configured to receive a signal transmission from a remote station;
a processor configured to determine if the signal transmission includes a discriminant applied to the signal transmitted from the remote station and to designate the signal transmission as being transmitted via the repeater if the signal transmission includes the discriminant.

12. The apparatus of claim 11, wherein the discriminant comprises a code.

13. The apparatus of claim 11, wherein the discriminant comprises a modulation applied to the signal transmission from the remote station.

14. The apparatus of claim 13, wherein the modulation comprises a delay modulation.

15. The apparatus of claim 13, wherein the modulation comprises a frequency modulation.

16. The apparatus of claim 13, wherein the discriminant comprises an amplitude modulation.

17. The apparatus of claim 15, wherein the repeater comprises an amplifier, and the amplitude modulation is applied to the signal transmission by performing the step of varying a gain of the amplifier.

18. The apparatus of claim 17, wherein the base station comprises a power control system configured to control the strength of the signal transmitted from the remote station, and wherein the amplitude modulation is performed at a frequency higher than the closed-loop bandwidth of the power control system.

19. The apparatus of claim 18, wherein the power control system further comprises:
an error signal related to a difference between the strength of the signal transmitted from the remote station and a desired strength of the signal transmitted from the remote station;
a processor configured to measure the error signal; and
detection module for designating the signal transmission as communicated via the repeater according to the measured error signal.

20. The apparatus of claim 11, wherein the remote communications can potentially be transmitted from one of a plurality of repeaters and the discriminant is unique to each of the plurality of repeaters.

21. An apparatus for identifying remote communications transmitted via a repeater, comprising:
means for receiving a signal transmission from a remote station;
means for determining if the signal transmission includes a discriminant applied to the signal transmitted from the remote station; and
means for designating the signal transmission as being transmitted via the repeater if the signal transmission includes the discriminant.

22. The apparatus of claim 21, wherein the discriminant comprises a code.

23. The apparatus of claim 21, wherein the discriminant comprises a modulation applied to the signal transmission from the remote station.

24. The apparatus of claim 23, wherein the modulation comprises delay modulation

25. The apparatus of claim 24, wherein the modulation comprises a frequency modulation.

26. The apparatus of claim 23, wherein the discriminant comprises an amplitude modulation.

27. The apparatus of claim 26, wherein the repeater comprises an amplifier, and the amplitude modulation is applied to the signal transmission by performing the step of varying gain of the amplifier.

28. The apparatus of claim 27, wherein the base station comprises a power control system for controlling the strength of the signal transmitted from the remote station, and wherein the amplitude modulation is performed at a frequency higher than the closed-loop bandwidth of the power control system.

29. The apparatus of claim 28, wherein the power control system includes an error signal related to a difference between the strength of the signal transmitted from the remote station and a desired strength of the signal transmitted from the remote station and the means for designating the signal transmission as being transmitted via the repeater if the signal transmitter includes the discriminant comprises:
means for measuring the error signal; and
means for designating the signal transmission as communicated via the repeater according to the measured error signal.

30. The apparatus of claim 21, wherein the remote communications can potentially be transmitted from one of a plurality of repeaters and the discriminant is unique to each of the plurality of repeaters.

31. A program storage device, readable by a computer, tangibly embodying at least one program of instructions executable by the computer to perform method steps of identifying remote communications transmitted via a repeater from remote communications not transmitted via the repeater, the method steps comprising the steps of:
receiving a signal transmission from a remote station;
determining if the signal transmission includes a discriminant applied to the signal transmitted from the remote station; and
designating the signal transmission as being transmitted via the repeater if the signal transmission includes the discriminant.

32. A method of distinguishing remote communications transmitted via a repeater from remote communications not transmitted via the repeater, comprising the steps of:
receiving a signal transmission in the repeater;
augmenting the received signal with a discriminant; and
transmitting the augmented received signal to a base station.

33. The method of claim 32, wherein the discriminant comprises a code.

34. The method of claim 32, wherein the discriminant comprises a modulation applied to the received signal transmission.

35. The method of claim 34, wherein the modulation is frequency modulation.

36. The method of claim 34, wherein the modulation is delay modulation.

37. The method of claim 34, wherein the modulation is amplitude modulation.

38. The method of claim 37, wherein the amplitude modulation is performed at a frequency higher than a closed loop bandwidth of a power control system.

39. The method of claim 32, wherein the remote communications are potentially transmitted from one of a plurality of repeaters and the discriminant is unique to each repeater.

40. A repeater for transmitting remote communications distinguishable as being transmitted by the repeater, comprising:
a server antenna for receiving a signal transmission from a remote station;
an amplifier communicatively coupled to the server antenna; and
a donor antenna, communicatively coupled to the amplifier, for transmitting a signal transmission comprising the received signal transmission augmented by a discriminant identifying the transmitted signal as originating from the repeater.

41. The repeater of claim 40, further comprising:
a device communicatively coupled to the donor antenna and the amplifier, the device for generating the augmented signal transmission.

42. The repeater of claim 41, wherein the discriminant comprises a code.

43. The method of claim 41, wherein the discriminant comprises a modulation applied to the received signal transmission.

44. The method of claim 43, wherein the modulation is frequency modulation.

45. The method of claim 43, wherein the modulation is delay modulation.

46. The method of claim 43, wherein the modulation is amplitude modulation.

47. The method of claim 46, wherein the amplitude modulation is performed at a frequency higher than a closed loop bandwidth of a power control system.

48. The method of claim 40, wherein the remote communications are potentially transmitted from one of a plurality of repeaters and the discriminant is unique to each repeater.
